(19) United States
(12) Patent Application Publication
(10) Pub. No.: US 2025/0085933 A1
(43) Pub. Date: Mar. 13, 2025

(54) METHOD FOR CREATING A CONTROL PROGRAM FOR A TARGET PLATFORM, DEVICE FOR DATA PROCESSING, COMPUTER PROGRAM PRODUCT, AND DATA MEDIUM

(71) Applicant: dSPACE GmbH, Paderborn (DE)

(72) Inventor: Michael MAIR, Paderborn (DE)

(73) Assignee: dSPACE GmbH, Paderborn (DE)

(21) Appl. No.: 18/828,944

(22) Filed: Sep. 9, 2024

(30) Foreign Application Priority Data
Sep. 7, 2023 (DE) 10 2023 124 151.6

(51) Int. Cl. G06F 8/34; G06F 9/30

(52) U.S. Cl. CPC G06F 8/34; G06F 9/30007

(57) ABSTRACT

A computer-implemented method for creating a control program for a target platform from a graphical control model of a development platform. The graphical control model includes a block diagram with a plurality of blocks. When creating the control program for the target platform from the graphical control model, block pairs that include a first block and a second block are identified, in which the first block and the second block are connected to one another via at least one signal link such that an output of the first block drives an input of the second block. The first block and the second block are designed in such that an input signal of the first block corresponds to an output signal of the second block or designed such that an input signal of the first block corresponds to an intermediate result of the second block.

This nonprovisional application claims priority under 35 U.S.C. § 119 (a) to German Patent Application No. 10 2023 124 151.6, which was filed in Germany on Sep. 7, 2023, and which is herein incorporated by reference.

### BACKGROUND OF THE INVENTION

### Field of the Invention

The invention relates to a computer-implemented method for creating a control program for a target platform from a graphical control model of a development platform.

The invention further relates to a method for configuring a target platform designed as a control unit, in which a control program for the target platform is created from a read-in graphical control model according to the above method.

The invention further relates to a device for data processing, including components, i.e. a processor, memory, etc. for executing the first-mentioned method.

The invention further relates to a computer program product that includes commands which, when the program is executed by a computer, prompt the computer to carry out the first-mentioned method.

The invention further relates to a computer-readable data medium on which the above computer program product is stored.

### DESCRIPTION OF THE BACKGROUND ART

Methods for computer-assisted creation of a control program from a graphical control model have been known for some time, and are part of the basic functionalities of development environments. In particular, such programs may be created for control systems such as control units, for example.

The graphical control model is often present in the form of a block diagram, by means of which, for example, the mathematical functionality of a control algorithm is modeled and represented. By use of the graphical control model, processes, controllers, and/or in general the behavior of the control unit may be initially simulated and the presence of desired properties may be checked. The block diagram that forms the model generally includes multiple blocks, connected via signal links, that carry out operations such as computations, wherein a block may, for example, compute an output signal from multiple input signals. Block diagrams are generally cyclically executed, wherein all blocks are continuously held in the memory, and each block is executed once per time increment. In particular, a block may apply one or more operations to input signals from the last time increment in order to generate output signals of the present time increment. Accordingly, common assumptions with regard to control programs, for example the lifetime of variables of the control program, are not readily transferable to the graphical control model.

In addition to a cyclically executed submodel for describing approximately time-continuous behavior of the control unit, graphical control models may also include a submodel for describing a discrete behavior in which a number of states and transition conditions are defined.

Methods for creating control programs from graphical control models are also referred to as code generators. This is a computer program that translates the graphical control model into source code of the selected target platform, i.e., into the control program. The control program, in contrast to the graphical control model, is present in completely textual form, and includes instructions for the execution on the target platform. Code generators thus ensure reliable and error-free implementation of an abstract functional description (graphical control model) into a program for the target platform (control system).

A method for creating a control program is described, for example, in the publication EP 4 148 557 A1, which corresponds to US 2023/0229403, which is incorporated herein by reference.

When creating control programs from graphical control models, a customary procedure is to generate a variable in the control program for each output of a block. However, this has the disadvantage that generally more block variables initially result than are actually necessary. The number of block variables, or in general the code size of the control program, may be reduced by subsequent optimization. Thus, it is known from EP 2 418 577 A1, which corresponds to US 2013/0263082, to transform a block diagram into an intermediate representation, and to apply at least one optimization to this intermediate representation in order to generate an optimized intermediate representation. A number of further optimizations, known per se from compiler construction, may be applied in succession to generate further optimized intermediate representations. The control program is subsequently generated from the optimized intermediate representation, in particular in C code.

Since each optimization results in a changed intermediate representation, the extent to which the code as a whole is optimized may be a function of the order of the optimization steps. In addition, in particular the different type of indexing of arrays in the graphical control models and in the control program, wherein the indices of arrays may start with 1 or with 0, results in situations that cannot be resolved by optimization of the intermediate representation.

### SUMMARY OF THE INVENTION

It is therefore an object of the present invention to refine the prior art, and in particular to assist with the creation of compact control programs.

According to an example of the invention, a computer-implemented method for creating a control program for a target platform from a graphical control model of a development platform is thus provided, wherein the graphical control model includes a block diagram with a plurality of blocks, wherein when creating the control program for the target platform from the graphical control model, block pairs that include a first block and a second block are identified, in which the first block and the second block are connected to one another via at least one signal link in such a way that an output of the first block drives an input of the second block, and in which the first block and the second block are designed in such a way that an input signal of the first block, within the scope of computational accuracy that is necessary for executing the control program, and for all values in a value range that is necessary for executing the control program, corresponds to an output signal of the second block; or the first block and the second block are designed in such a way that an input signal of the first block, within the scope of computational accuracy that is necessary for executing the control program, and for all values in a value range that is necessary for executing the control program, corresponds to an intermediate result of the second block, and the second block is designed in such a way that for an operation of the second block that uses the intermediate result, an input signal of this operation is replaceable.

Thus, one aspect of the invention is that in the graphical control model, block pairs are identified in which the successive blocks execute opposite and/or inverse operations. In case i), the result of the two blocks, i.e., the output signal of the second block within the scope of the computational accuracy that is necessary for executing the control program, and for all values in the value range that is necessary for executing the control program, has an identical behavior to the input signal of the first block. In case ii), the second block includes the operation that is the opposite and/or inverse to the first block as part of its block code pattern in a form that is replaceable in the block code pattern. In the present context, “block code pattern” in the narrower sense may be understood to mean a specific characteristic of a block with a certain parameterization and one or more specific input signals in portions of the control program, which is preferably present in C code. In addition, in the present context, “block code pattern” in the broader sense can also be understood to mean the operations and computing steps of the block that are defined in the block at the level of the graphical control model, and that are applied to the input signal and/or the intermediate results in order to generate the output signal or state values of the particular block. Furthermore, in case ii) the intermediate result of the second block within the scope of the computational accuracy that is necessary for executing the control program, and for all values in the value range that is necessary for executing the control program, has an identical behavior to the input signal of the first block.

The invention allows recognition of these situations, in which a user has modeled a model, using the block diagram, in which opposite operations are carried out in two successive blocks, and provides the option of removing the unnecessary computation steps. In case i), laborious computations on a signal link of the second block to a successor block of the second block may be dispensed with, while in case ii), laborious computation in the identified block pair may be dispensed with. The invention thus provides the option for avoiding the application of unnecessary code for the blocks subsequent to the block pair. In other words, the invention allows the signal links and block parameters in the block diagram to be modified during the code generation in such a way that the behavior of the model does not change, but the unnecessary operations are not even contained in the initially applied code.

Thus, in other words, the graphical control model is present in the form of a block diagram, which preferably comprises a plurality of blocks that are connected to one another via the signal links. The blocks in the block diagram may be atomic; i.e., from the viewpoint of the surrounding blocks they form a unit in which at the start of a computing step all input signals must be present, and at the end of a computing step all output signals are present. When block diagrams are hierarchical, a plurality of blocks in a lower-order level may describe the structure of a block in a higher-order level. Hierarchical or composite blocks, even if they are atomic, may include a plurality of blocks in a lower-order level. Composite blocks may in particular be subsystems; subsystems may have additional properties, such as implementation in a separate function and/or triggering of the execution of the subsystem via a dedicated signal. Specialized blocks may be situated in subsystems in order to further specify the properties of the subsystem.

Within the meaning of the invention, in the present context block pairs, in which the first block and the second block are connected to one another via at least one signal link in such a way that an output of the first block drives an input of the second block, can also be understood to mean block pairs in the block diagram that are connected to one another beyond subsystem boundaries. In addition, they can also be understood to mean block pairs in which further blocks are connected between the first block and the second block, but which, however, do not change the signal that is transmitted on the signal link, for example blocks pertaining to signal routing or blocks that combine multiple signals and subsequently separate them into individual signals.

Data or signals may be transferred via the signal link of the first block to the second block; the first block outputs a value or, depending on the definition, multiple related values, and the second block receives these as its input signal and takes them into account in determining its output signal, i.e., in determining one or more related output values. Signals may contain scalar variables and/or structured data types such as arrays, as is the case for a bus, for example.

When a block includes the access to a multicomponent variable, the saving of an operation that accesses this variable may enable considerable savings of memory space and execution time, for example in that instructions for this purpose are not generated in the code at all, and accordingly also do not have to be executed at runtime. The multicomponent variable may be a vector that includes a plurality of variables of the same data type, or a matrix that includes a plurality of vectors having a structure that includes a plurality of variables of any given data type, or a vector, or a matrix of structures.

The step of creating the control program may include a plurality of substeps, such as checking a number of rules and appending further code generation information. In principle, the identification according to the invention may take place in any given intermediate step.

An aspect as mentioned above is that passing through of the input value of the first block by opposite and/or inverse operations in successive blocks, which in principle represents a computation-intensive option, is identified. In particular within the scope of the computational accuracy that is necessary for the control program, the output signal of the second block or the intermediate result of the second block corresponds to the input signal of the first block, and has the same behavior for all values in the value range that is necessary for the control program.

The identification of block pairs that are designed according to i) and/or ii) preferably includes an analysis of the operations carried out by the blocks. It is further preferred that for block pairs in which the first block and the second block are connected to one another via at least one signal link in such a way that the output of the first block drives the input of the second block, operation pairs are identified which are opposite and/or inverse to one another. Whether an operation of a block is opposite and/or inverse to an operation of another block preferably depends not only on the type of operation, but also on the data type being processed by the operation, the computational accuracy, and/or the value range being considered. Thus, for example, the operation that squares a value is opposite to the operation that extracts the square root from a value, provided that the value range of positive numbers is considered. Furthermore, when the data type is an integer, adding the integer 1 and subtracting the integer 1 are independent of the computational accuracy of opposite operations. However, when the data type is a floating-point number, the computational accuracy that is necessary for the control program is a function of whether the addition of a value and the subtraction of the same value represent opposite operations. The term “computational accuracy that is necessary for the control program” can be understood, for example, to mean the computational accuracy that is necessary for the functionality of the control program. Furthermore, the term “value range that is necessary for the control program” can be understood to mean the value range that may be occupied by a signal during execution of the control program.

For the identification of block pairs that are designed according to i) and/or ii), it is preferably further provided that a list containing operation pairs that are regarded as opposite and/or inverse operations under a certain boundary condition is stored in a database. When, in a block pair in which the first block and the second block are connected to one another via at least one signal link in such a way that the output of the first block drives the input of the second block, operation pairs have been identified which in the list are regarded as opposite and/or inverse operations, in a further step it is preferably checked whether these operations are also opposite and/or inverse operations within the scope of the present block diagram, preferably by analyzing the value and the behavior of the input signal of the first block and the value and the behavior of the output signal of the second block, or the value and the behavior of the intermediate result in the second block. It is particularly preferably checked whether the operation of the first block and the operation of the second block, for the specific block diagram and the data type being transferred on the signal link, deliver, in terms of fixed-point accuracy, the same behavior of the result of the two operations to the input signal of the first block.

When a block pair that is designed according to i) is identified during creation of the control program, the control program can be created in such a way that it corresponds to a modified block diagram in which a branch prior to the first block, via the input signal of the first block, drives a successor block of the second block while bypassing the first and second blocks. In other words, the situation that the two blocks execute opposite and/or inverse operations is thus resolved by creating a branch prior to the first block, so that the input signal of the first block is directly connected to the successor block of the second block while bypassing the first and second blocks. It is also particularly preferred for the signal link of the second block to the successor block of the second block to be disconnected from the successor block. If the second block, apart from the successor block described here, has no other successor that processes the output signal of the second block, the signal link transmitting the output signal of the second block is preferably terminated. Laborious computations on the signal link are thus dispensed with for all successors of the block pair.

In this regard, it is further preferably provided that in the case that the signal link transmitting the output signal of the second block is terminated, the block code pattern of the second block can also preferably be adapted in such a way that the opposite and/or inverse operation in the second block are/is not computed at all.

Further, when a block pair that is designed according to ii) is identified during creation of the control program, the control program can be created in such a way that it corresponds to a modified block diagram in which a branch prior to the first block, via the input signal of the first block, drives the second reparameterized block while bypassing the first block, and for the reparameterized block, the input signal of the operation using the intermediate result is replaced by the input signal of the first block. In other words, the situation that the second block, as part of its block code pattern, contains the operation that is the inverse to the operation carried out by the first block, and the inverse operation may be switched off, is thus resolved in such a way that a branch is created prior to the first block, so that the input signal of the first block is directly connected to the reparameterized second block while bypassing the first block. The signal link of the first block to the second reparameterized block is preferably eliminated. In addition, the second block is reparameterized in order to bypass carrying out the operation that achieves the intermediate result.

If, due to eliminating the signal link to the second reparameterized block, the first block has no other successor which processes the output signal of the first block, the signal link that transmits the output signal of the first block is preferably terminated. Laborious computation in the block pair is thus dispensed with.

In this regard, it is further preferably provided that in the case that the signal link transmitting the output signal of the first block is terminated, the block code pattern of the first block can preferably also be adapted in such a way that the operation in the first block, which is inverse to the operation of the second block that achieves the intermediate result, is not computed at all.

The control program can be created in such a way that it corresponds to a multiply modified block diagram in which, after a first modification of the block diagram, one or more further identifications of a block pair that is designed according to i) and/or ii) and corresponding modification of the block diagram take place. In other words, the block diagram corresponding to the control program is preferably not modified just once after checking whether block pairs with opposite and/or inverse operations are present, but instead the procedure is preferably carried out multiple times.

When a block pair that is designed according to i) and/or ii) is identified during creation of the control program, a warning can be generated. Instead of or in addition to the above-described behavior, in which the control program is created in such a way that it corresponds to a modified or multiply modified block diagram, it may be advantageous to notify the user by generating a warning about the situation. In particular in cases in which the model modification is not possible or is particularly complicated, it may be reported to the user that unnecessary computations may be avoided by remodeling.

The first and/or second block may be designed as different types. The second block of the block pair can be designed as a selector block or as an assignment block. Thus, one or more of the following types of blocks are preferably checked with regard to the design of the block pair according to i) or ii): a selector block that extracts selected elements from a vector, a matrix, or a multidimensional signal; an assignment block that assigns the values to elements of a signal.

As a result of in particular the different type of indexing of arrays in the graphical control model and in the control program, wherein the indices of arrays preferably start with 1 in the graphical control model and the indices of arrays preferably start with 0 in the control program, accesses to indices of arrays are automatically implemented with a −1 assignment for the created control program. However, for block configurations in the graphical control model in which the user converts zero-based indexing into one-based indexing by means of a modeled +1 operation, the described behavior results in the cancellation of computing steps in which the index value is needlessly increased by +1 and is subsequently decreased back to −1 (or vice versa). In such situations, as previously mentioned, during creation of the control program the modeled increase by +1 is preferably offset by the decrease by −1 from the one-based indexing by bypassing the +1 operation.

As previously mentioned, it is preferably provided that the first block and the second block of the block pair execute inverse operations and/or opposite operations. In this regard, according to a further preferred refinement of the invention it is provided that the first and second blocks of the block pair are designed in such a way that they carry out: additive inverse operations, logical inverse operations, bitwise inverse operations, inverse mathematical functions, multiplicative inverse operations, opposite data type conversions, and/or linkages thereof.

the first and second blocks of the block pair can be designed in such a way that they carry out linkages of operations which as a whole are inverse to one another.

Additive inverse operations are operations that when added to one another result in the additive neutral element. In particular, the above-described increase of an index by +1 and subsequent decrease by −1 is an example of two additive inverse operations, where in the present case the additive neutral element is 0.

A logical operation is a function that supplies a truth value and/or operates on a truth value. In two-valued Boolean logic, the operation thus supplies “true” or “false,” and for a multi-value logic other values may also be correspondingly supplied. An example of two logical inverse operations is represented by two logical exclusive OR operations, also referred to as XOR, which have the same second input value for the first block and the second block. Another example is the logical NOT operation as an operation for both blocks.

A bitwise operation is an operation that is carried out on one or two bit chains, bit fields, bit sequences, and/or bit vectors on the individual bit level. An example for bitwise inverse operations is represented by two cyclic shifts having opposite numbers (also referred to as bitwise rotation or circular shift), for example a cyclic left shift by 2 bits followed by a cyclic right shift by 2 bits.

With regard to the logical operations and the bitwise operations, in many programming languages, in particular the C family, a distinction is made between bitwise (multicomponent and component-by-component) and logical (Boolean, i.e., a single component).

For inverse mathematical functions, in the present case these involve two functions in which one function assigns to each element of a pre-image set an element of a target set, and the other function correspondingly assigns to each element of the target set its uniquely determined pre-image element. For example, this involves the functional pair of sine and arcsine, exponential function and logarithmic function, or quadratic function and square root function.

Multiplicative inverse operations are operations which when multiplied by one another result in the neutral element. For example, multiplying by 7, followed by dividing by 7, is an example of two multiplicative inverse operations, where in the present case the multiplicatively neutral element is 1.

Opposite data type conversions are conversions of the data type, also referred to as type conversions, which when performed in succession generate the original data type. An example is a conversion of an integer having a size of 16 bits into a 32-bit integer, and a further conversion back into the size of 16 bits.

Of course, the first block and the second block of the block pair may also be designed in such a way that they carry out linkages of operations that are opposite and/or inverse overall. In one example, the first block carries out a type conversion followed by a left shift, i.e., a bitwise operation, wherein the type conversion takes place over a fairly large value range in such a way that no bits are lost during the left shift, and the second block carries out a right shift followed by the type conversion to the original type and value range. In this example, the type conversion allows the block operations to be considered as inverse bitwise operations, so that they may be bypassed.

Creating the control program for the target platform from the graphical control model of the development platform can comprises the steps: generating an intermediate representation from the graphical control model, optimizing the generated intermediate representation, and creating the control program for the target platform by translating the optimized intermediate representation, wherein at least one of the steps, and in particular the step of generating the intermediate representation, includes identifying block pairs that are designed according to i) and/or ii).

As a method for creating the control program from the graphical control model, it is preferably provided that creating the control program includes transforming the block diagram into the intermediate representation, preferably successively optimizing the intermediate representation, and translating the optimized intermediate representation into the control program, wherein in particular block pairs that are designed according to i) and/or ii) are already identified during the generation of the intermediate representation. Since the identification preferably takes place during the transformation into the intermediate representation, all information in the block diagram is still available. It is thus possible in particular to take into account the result of block diagram transformations and/or to select or force an execution sequence of the blocks that is suitable for the optimization, provided that the corresponding degrees of freedom are present.

In the intermediate representation, the blocks in the block diagram can be preferably translated into instructions with a fixed execution sequence, as a result of which the structure of the intermediate representation semantically depicts a textual programming language.

The block pairs that are designed according to i) and/or ii) are preferably not just identified; rather, a modification of the block diagram preferably also takes place during the transformation. In this regard, according to one preferred refinement of the invention it is provided that when a block pair that is designed according to i) is identified, the intermediate representation is created in such a way that it corresponds to a modified block diagram in which a branch prior to the first block, via the input signal of the first block, drives a successor block of the second block while bypassing the first and second blocks.

Analogously, according to an example of the invention it is provided that when a block pair that is designed according to ii) is identified, the intermediate representation is created in such a way that it corresponds to a modified block diagram in which a branch prior to the first block, via the input signal of the first block, drives the second reparameterized block while bypassing the first block, and for the reparameterized block the input signal of the operation using the intermediate result is replaced by the input signal of the first block.

The step of transforming may include a plurality of substeps, such as checking a number of rules and appending further code generation information. In principle, the identification and subsequent modification may take place in any given intermediate step of the transformation.

The method according to the invention advantageously identifies block pairs that are designed according to i) or ii) and changes the signal links and/or the block parameterization in order to avoid unnecessary computing operations, so that they do not have to applied at all during the creation of the intermediate representation. As a result, not only is more efficient code generated overall, but also the optimization of the intermediate representation is speeded up, since fewer computing operations have to be considered at the very start.

In this regard, it is provided that the optimizing of the generated intermediate representation can include renewed identification of block pairs that are designed according to i) and/or ii) in the modified block diagram corresponding to the intermediate representation. Alternatively or additionally, it may be provided that the optimizing of the generated intermediate representation includes generation of an optimized intermediate representation that corresponds to a multiply modified block diagram in which after a first modification of the block diagram, one or more further identifications of a block pair that is designed according to i) and/or ii) and corresponding modification of the block diagram take place. In other words, when generating the intermediate representation, it is preferably not checked just once whether block pairs with opposite and/or inverse operations are present, and instead an identification and appropriate modification are carried out multiple times.

The control program can be created in C code. In the present context, C code can be understood to mean a programming language that is derived from the syntax and/or the basic language development of C. Such languages have, for example, instructions enclosed by semicolons, code blocks separated by curly brackets, parameters separated by parentheses, and/or arithmetic and logical expressions defined in infix notation. They are also sometimes referred to as “languages with curly brackets.” In the present context, C code also preferably includes code in the programming language C++, Handel-C, and/or SA-C. It is further preferred that this can be understood to mean a standardized form of C code such as ANSI C, ANSI C++, ISO C, ISO C++, Standard C, and/or Standard C++, published by the American National Standards Institute (ANSI), ISO/IEC JTC 1/SC 22/WG 14 of the International Organization for Standardization (ISO), ISO/IEC JTC 1/SC 22/WG 21 of the C++ Standards Committee—ISOCPP of the International Organization for Standardization (ISO), and/or the International Electrotechnical Commission (IEC).

The invention further relates to a method for configuring a target platform designed as a control unit, wherein the target platform includes at least one processing unit, and preferably has at least one sensor and/or actuator for detecting data of a physical process and/or acting on a physical process, comprising the steps: reading in a graphical control model of a development platform, creating a control program for the target platform from the read-in graphical control model, using the method according to the method described above, generating an executable code for the processing unit of the target platform by compiling the created control program, and/or transferring the generated executable code to the target platform and/or storing the generated executable code on a nonvolatile memory of the target platform and/or executing the generated executable code by the processing unit of the target platform.

The control unit preferably includes an interface for connection to the development platform. It is further preferred that the control unit includes a microcontroller with an architecture that is different from a processor of the development platform, a working memory, and a nonvolatile memory.

The invention further relates to a device for data processing, including components, i.e., a processor, memory, etc. for carrying out the above-described computer-implemented method for creating the control program.

The invention further relates to a computer program product that includes commands which, when the program is executed by a computer, prompt the computer to carry out the above-described computer-implemented method for creating the control program.

The invention further relates to a computer-readable data medium on which the above computer program product is stored.

The commands on the computer-readable data medium are preferably embedded, and the commands, when executed by a processor of the computer, cause the processor to carry out the method for creating the control program.

The technical advantages and effects of the method for configuring the target platform designed as a control unit, the device for data processing, the computer program product, and the computer-readable data medium will become apparent to those skilled in the art by the description of the method for creating the control program, and by the examples described below.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a device for data processing according to an example of the invention,

FIG. 2 schematically shows the software components installed on the device according to FIG. 1,

FIG. 3 schematically shows a flow chart of a method for creating a control program for a target platform from a graphical control model according to an example of the invention,

FIG. 4a schematically shows a block diagram of a graphical control model from which a control program is created by use of the method for creating a control program, according to an example of the invention,

FIG. 4b schematically shows a modified block diagram,

FIG. 5a schematically shows a further block diagram from which a control program is created by use of the method for creating a control program, according to one an example of the invention,

FIG. 5b schematically shows a modified block diagram,

FIG. 6a schematically shows a further block diagram from which a control program is created by use of the method for creating a control program, according to an example of the invention, and

FIG. 6b schematically shows a modified block diagram.

### DETAILED DESCRIPTION

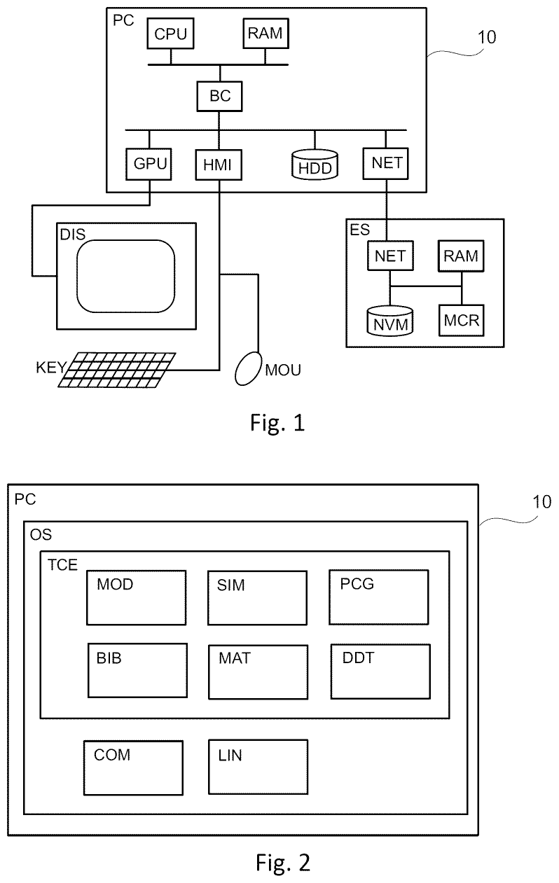

FIG. 1 schematically shows an example of a device 10 for data processing, in the present case referred to as a computer system PC. The computer system PC is configured to carry out a method for creating a control program for a target platform from a graphical control model of a development platform, i.e., the computer system. The computer system PC has a processor CPU which in particular may be implemented as a multi-core processor, and a working memory RAM and a bus controller BC. The computer system PC is preferably designed to be directly operated manually by a user, a monitor DIS being connected via a graphics card GPU, and a keyboard KEY and a mouse MOU being connected via a human-machine interface HMI. In principle, the human-machine interface of the computer system PC could also be designed as a touch interface. The computer system PC also includes a nonvolatile data memory HDD, which in particular may be designed as a hard disk and/or solid-state disk, and an interface NET, in particular a network interface. A control unit ES, i.e., the target platform, may be connected via the interface NET. In principle, one or more of any given interfaces, in particular wired interfaces, may be present at the computer system PC and usable in each case for connection to a control unit ES. A network interface according to the Ethernet standard may advantageously be used; the interface NET may also have a wireless design, in particular as a WLAN interface or according to a standard such as Bluetooth.

The control unit ES may be designed as a series controller or as an evaluation board for the target platform. The control unit advantageously includes an interface NET for connection to the computer system PC, a microcontroller MCR with an architecture that is different from the processor of the computer system PC, a working memory RAM, and a nonvolatile memory NVM.

FIG. 2 illustrates a diagram of the software components that are preferably installed on the computer system PC. These software components use mechanisms of the operating system OS, for example to access the nonvolatile memory HDD or to establish a connection with an external computer and/or the control unit ES via the network interface NET.

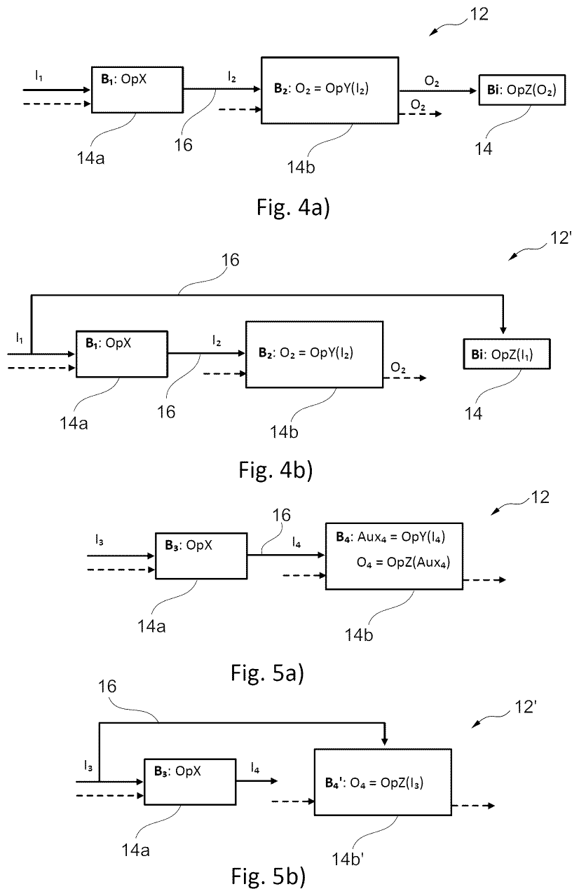

A technical computing environment TCE allows the creation of models, in particular graphical control models 12 (shown in FIGS. 4, 5, and 6), and the creation of a control program, also referred to as source code, from the graphical control models 12. Graphical control models 12 of a dynamic system may be created in a modeling environment MOD, preferably via a graphical user interface. This may in particular involve block diagrams 12 that include multiple blocks 14 (shown in FIGS. 4, 5, and 6) and that describe the temporal behavior and/or internal states of a dynamic system. At least some of the blocks 14 are connected to one another via signal links 16 (shown in FIGS. 4, 5, and 6), wherein the signal links 16 represent directed connections for the exchange of data, and the data may be scalar or aggregated. Operations and/or computing steps to be carried out on the data may be defined via the blocks 14. Blocks 14 may be atomic; i.e., from the viewpoint of the surrounding blocks 14 they form a unit in which at the start of a computing step all input signals must be present, and at the end of a computing step all output signals are present. When block diagrams 12 are hierarchical, a plurality of blocks 14 in a lower-order level may describe the structure of a block 14 in a higher-order level. Hierarchical or composite blocks 14, even if they are atomic, may include a plurality of blocks 14 in a lower-order level. Composite blocks 14 may in particular be subsystems; subsystems may have additional properties, such as implementation in a separate function and/or triggering of the execution of the subsystem via a dedicated signal. Specialized blocks 14 may be situated in subsystems in order to further specify the properties of the subsystem.

The computing environment TCE includes one or more libraries BIB from which blocks 14 or components for building a model 12 may be selected. In a script environment MAT, instructions may be input interactively or via a batch file in order to perform computations or to modify the model 12. The computing environment TCE also includes a simulation environment SIM that is configured to interpret or execute the block diagram 12 in order to examine the temporal behavior of the system. These computations preferably take place using highly accurate floating point numbers on one or more cores of the microprocessor CPU of the computer system PC.

By use of a code generator PCG, the source code may be generated from a created model 12, preferably in a programming language such as C. For this purpose, in the present example, the method for creating a control program for a target platform from the graphical control model 12 of the development platform is carried out. Additional information concerning the model 12, in particular the variables in the blocks 14 (referred to as block variables), is advantageously stored in a definition data table DDT. Value ranges and/or scalings are advantageously assigned to the block variables to assist with computation by the model 12, using fixed-point instructions. Desired properties of the source code, for example conformity with a standard such as MISRA, may also be set or stored in the definition data table DDT. Each block variable is advantageously assigned to a predefined variable type, and one or more desired properties, for example the permissibility of optimizations such as aggregation of variables, are set. In addition, information about opposite and/or inverse operations of the blocks 14 may also be stored in the definition data table DDT.

The code generator PCG preferably evaluates the settings of the definition data table DDT and takes them into account when generating the source code. The definition data table DDT may have a tree structure, or may be stored as a simple file in a memory of the computer system; alternatively, it may be provided to store the definition data in a dedicated database system. The definition data table may have a program interface and/or import/export functions.

In this example, the computer system PC has a compiler COM and a linker LIN that are advantageously configured to create binary files that are executable on a control unit ES and/or the computer system PC. In principle, a plurality of compilers, in particular cross compilers for different target platforms, may be present to assist control units or evaluation boards ES having different processor architectures.

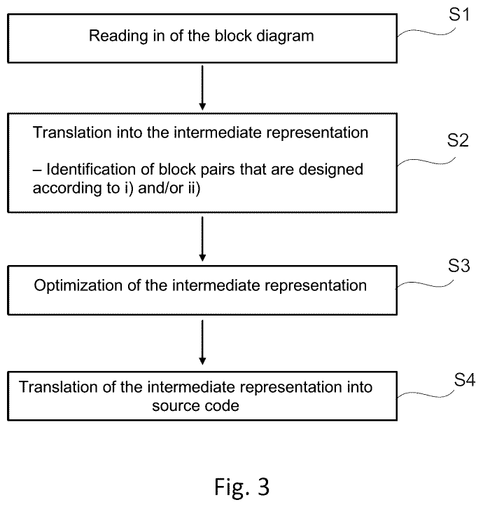

FIG. 3 shows a schematic flow chart of an example of the method according to the invention for creating a control program for a target platform from the graphical control model 12 of the development platform. The method may be completely carried out by a processor in an example of the computer system PC; however, it may also be provided to carry out the method in a client-server environment, using an operating computer and one or more servers that are connected via a network, in particular computation-intensive steps being carried out on the servers.

A graphical control model 12 that includes a block diagram 12 is read in in step S1 (reading in of the block diagram). Examples of block diagrams 12 are illustrated in FIGS. 4 through 6. The block diagram 12 includes at least one block pair that is made up of two blocks 14a, 14b which are connected to one another via at least one signal link 16 in such a way that an output of the first block 14a drives an input of the second block 14b. The block diagram 12 may contain a plurality of further blocks 14. The reading in of the block diagram 12 also advantageously encompasses reading out from the definition data table DDT at least one block property and/or settings that is/are relevant for the code generation, for example the data type of a variable.

In step S2 (transformation into an intermediate representation), the graphical control model 12 is transformed into an intermediate representation which preferably includes one or more hierarchical graphs. This may in particular be a data flow graph, a control flow graph, or a tree structure. In addition to the block diagram 12, during generation of the intermediate representation further information from a definition data table DDT is advantageously taken into account or is incorporated into the intermediate representation. This may also include situations in which elements are generated based on information in the definition data table DDT, or properties of elements or settings that are relevant for the code generation, for example the data type of a variable, are extracted from the definition data table DDT.

During the transformation into the intermediate representation, block pairs are identified in the block diagram 12 for which the first block and the second block 14a, 14b are connected to one another via at least one signal link 16 in such a way that an output of the first block 14a drives an input of the second block 14b, and in which: i) the first block 14a and the second block 14b are designed in such a way that an input signal I₁ of the first block 14a corresponds to an output signal O₂ of the second block 14b; or ii) the first block 14a and the second block 14b are designed in such a way that an input signal I₃ of the first block 14a corresponds to an intermediate result Aux₄ of the second block 14b, and the second block 14b is designed in such a way that for an operation OpZ of the second block 14b that uses the intermediate result Aux₄, an input signal of this operation OpZ is replaceable.

In the present example, specifically designed block pairs are identified during the transformation into the intermediate representation. This is explained in greater detail, in particular with reference to FIGS. 4a) and 5a): FIG. 4a) shows a block diagram 12 in which the operation OpX is carried out on the input signal I₁ in the first block 14a, also denoted by reference symbol B₁. This gives the result I₂, which drives the input of the second block B₂. The operation OpY is carried out on the signal I₂ in the second block 14b, also denoted by reference symbol B₂, and this is passed on to a successor block B₁ as an output signal O₂. The operations OpX and OpY are inverse to one another, so that the following applies: OpX∘OpY=Id. In the present case, Id denotes the identity operator, which returns the input signal unchanged. Similarly, the output signal O₂ of the second block 14b, B₂ corresponds to the input signal I₁ of the first block 14a, B₁.

FIG. 5a) shows a block diagram 12 in which the operation OpX is carried out on the input signal I₃ in the first block 14a, also denoted by reference symbol B₃. This gives the result I₄, which drives the input of the second block 14b, also denoted by reference symbol B₄. In block B₄, the operation OpY on the signal I₄ generates the intermediate result Aux₄, which is then further processed in the subsequent operation OpZ in the second block. The operations OpX and OpY are inverse to one another, so that the following applies: OpX∘OpY=Id. Id denotes the identity operator, which returns the input signal unchanged. Similarly, the intermediate result Aux₄ corresponds to the input signal I₃ of the first block B₃. In addition, the second block B₄ is designed in such a way that for the operation OpZ that uses the intermediate result Aux₄, the input signal of this operation is replaceable.

The present example does not involve just the identification of the specific block pairs, designed according to i) or ii), during the transformation into the intermediate representation. In addition, the intermediate representation is directly generated in such a way that it corresponds to a modified block diagram 12′, which has the same behavior as the original block diagram 12, but which does not contain unnecessary operations or connections.

Thus, in the present case, during the identification of a block pair that is designed according to i), the intermediate representation is generated in such a way that it corresponds to a modified block diagram 12′ in which a branch prior to the first block 14a, via the input signal I₁ of the first block 14a, drives a successor block B₁ of the second block 14b while bypassing the first and second blocks 14a, 14b. This is apparent in FIG. 4b), which shows the modified block diagram 12′. A branch is present therein which relays the input signal I₁ of the first block B₁ to the successor block B₁ while bypassing the first block 14a, B₁ and bypassing the second block 14b, B₂. In addition, the signal link between the second block 14b, B₂ and the successor block B₁ is eliminated.

Furthermore, in the present case, during the identification of a block pair that is designed according to ii), the intermediate representation is generated in such a way that it corresponds to a modified block diagram 12′ in which a branch prior to the first block 14a drives, via the input signal I₃ of the first block 14a, the second reparameterized block 14b′ while bypassing the first block 14a, and for the reparameterized block 14b′ the input signal of the operation OpZ that uses the intermediate result Aux₄ is replaced by the input signal I₃ of the first block 14a. This is apparent in FIG. 5b), which shows the modified block diagram 12′. A branch is present therein which relays the input signal I₃ of the first block 14a, B₃ to the second reparameterized block 14b′, B₄′ while bypassing the first block 14a, B₃. In the reparameterized block 14b′, B₄′, the input signal of the operation OpZ that uses the intermediate result Aux₄ is replaced by the input signal I₃ of the first block 14a, B₃. In addition, the signal link between the first block 14a, B₃ and the second reparameterized block 14b′ B₄′ is eliminated.

As a result of directly creating the intermediate representation in such a way that it corresponds to a modified block diagram 12′, unnecessary computing operations and signal links 16 may be avoided, so that they do not have to be applied at all during the generation of the intermediate representation. As a result, not only is more efficient code generated overall, but also the subsequent optimization of the intermediate representation is speeded up, since fewer computing operations have to be considered at the very start.

Returning to FIG. 3, in step S3 (further optimization of the intermediate representation) the intermediate representation is optimized, and in particular the hierarchical graphs are optimized to reduce the number of required variables and/or memory consumption, for example stack allocation and/or the number of operations or processor instructions and/or the execution time of the source code. This optimization may include a plurality of intermediate steps in which further intermediate representations between the model/block diagram 12 and the source code/program text are generated. In particular, it may be provided in each intermediate step to convert a set of original hierarchical graphs into another set of altered hierarchical graphs, with application of one or more optimization rules. Various strategies such as “constant folding” or an elimination of “dead code” may be applied during the optimization. In principle, it is possible to combine multiple variables, generated within the scope of the transformation, in step S3.

In step S4 (translation of the intermediate representation into source code), the optimized intermediate representation or the optimized hierarchical graphs, which result from the entirety of intermediate steps carried out, is translated into source code of a textual programming language, in the present case C code. A further optimization may also take place in this step, in particular in such a way that the generated instructions represent a subset of the instructions included in principle in the language, and/or the generated control structures represent a subset of the control structures included in principle in the language. This allows precisely defined rules to be fulfilled. Alternatively or additionally, it may be provided to generate additional information, for example a reference between a program line and a block 14 of the block diagram 14, and to incorporate it into the source code, in particular in the form of comments, to improve the readability of the source code and/or to simplify debugging.

During or after the code generation, information concerning the present, i.e., the modified or multiply modified, block diagram 12′ or results of the code generation, for example generated warnings, may be stored in the definition data table DDT. This information may be used, for example, to influence compiling of the generated source code or to provide metainformation for other tools, for example calibration information in the ASAP2 format, or information concerning generation of an intermediate layer according to the AUTOSAR standard.

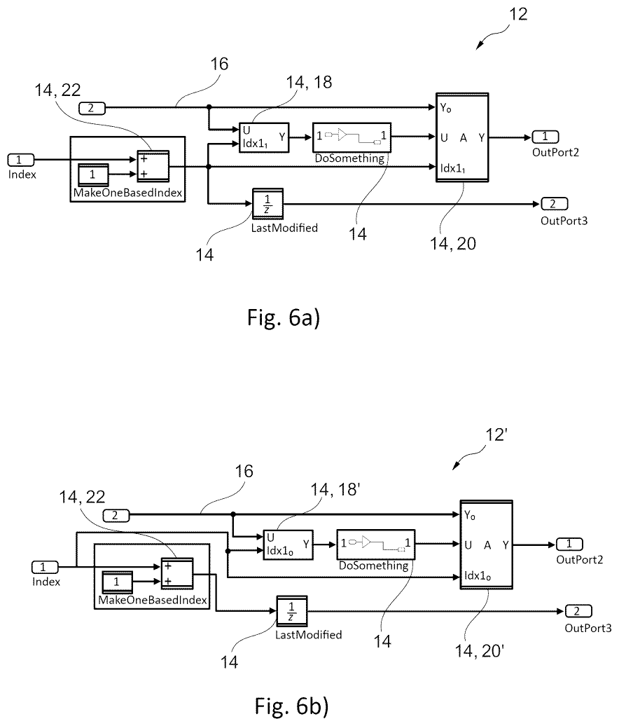

A further example of the invention is explained below with reference to FIG. 6. In the development platform in the graphical control model 12, array indices typically start with 1. In the development platform, for the blocks 14, namely, the selector block 18 and the assignment block 20, the user thus obtains one-based indexing, i.e., indexing that starts with 1. In the programming language C in which the control program is created, array indices typically start with 0. When the control program is created, the block diagram 12 specified by the user is implemented, and correspondingly the index accesses in the generated C code are implemented with “−1” accesses.

However, in certain situations described below by way of example, the index is already present in the graphical control model 12 as zero-based indexing, and the user corrects the index in the control model 12 with a modeled +1 operation. FIG. 6a) shows that for the selector block 18 and the assignment block 20, one-based indexing is present for the index inputs. The summation block 22 computes the corresponding index value first.

A code generation in pseudocode for precisely the block diagram 12 illustrated in FIG. 6a), and during creation of the code, without the code being created in such a way that it corresponds to a modified block diagram, results in the following:

MakeOneBasedIndex = Index + 1;
Selector = Array[MakeOneBasedIndex − 1];
R = DoSomething(Selector);
for (i = 0; i < WIDTH; i++) {
Assignment[i] = Array[i];
}
Assignment[MakeOneBasedIndex − 1] = R;
LastModified = X_LastModified;
X_LastModified = MakeOneBasedIndex;

This code can be compared only to a code, described below, in which, during the creation of the code for the target platform from the graphical control model 12, when the intermediate representation is created it is created in such a way that it corresponds to the modified block diagram 12′ shown in FIG. 6b), in which a branch prior to the summation block 22, via the input signal of the summation block 22, drives the reparameterized selector block 18′ and the reparameterized assignment block 20′ while bypassing the summation block 22, wherein in the reparameterized selector blocks and assignment blocks 18′, 20′, the input signal is replaced by the input signal of the summation block 22. In other words, the modeled increase by +1 is offset by the −1 from the one-based indexing by bypassing the +1 computation. In FIG. 6b) it is apparent that a direct connection of the index signal (input signal of the summation block 22) to the reparameterized selector blocks and assignment blocks 18′, 20′ is present, and that the reparameterized selector block 18′ and the reparameterized assignment block 20′ are each converted to zero-based indexing. This modeling 12′, which has the same behavior as the modeling 12 in FIG. 6a), avoids inverse operations such as the following, based on code generation in pseudocode that is generated based on the model 12′ in FIG. 6b):

MakeOneBasedIndex = Index + 1;
Selector = Array[Index];
R = DoSomething(Selector);
for (i = 0; i < WIDTH; i++) {
Assignment[i] = Array[i];
}
Assignment[Index] = R;
LastModified = X_LastModified;
X_LastModified = MakeOneBasedIndex;

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for creating a control program for a target platform from a graphical control model of a development platform, the graphical control model includes a block diagram with a plurality of blocks, the method comprising:
identifying, when creating the control program for the target platform from the graphical control model, block pairs that include a first block and a second block; and
connecting the first block and the second block to one another via at least one signal link such that an output of the first block drives an input of the second block, and in which:
i) the first block and the second block are designed in such a way that an input signal of the first block, within a scope of computational accuracy that is necessary for executing the control program, and for all values in a value range that is necessary for executing the control program, corresponds to an output signal of the second block; or
ii) the first block and the second block are designed in such a way that an input signal of the first block, within the scope of computational accuracy that is necessary for executing the control program, and for all values in a value range that is necessary for executing the control program, corresponds to an intermediate result of the second block, and the second block is designed in such a way that for an operation of the second block that uses the intermediate result, an input signal of this operation is replaceable.

2. The method according to claim 1, wherein when a block pair that is designed according to i) is identified, the control program is created in such a way that it corresponds to a modified block diagram in which a branch prior to the first block, via the input signal of the first block, drives a successor block of the second block while bypassing the first and second blocks.

3. The method according to claim 1, wherein when a block pair that is designed according to ii) is identified, the control program is created in such a way that it corresponds to a modified block diagram in which a branch prior to the first block, via the input signal of the first block, drives the second reparameterized block while bypassing the first block, and for the reparameterized block, the input signal of the operation using the intermediate result is replaced by the input signal of the first block.

4. The method according to claim 2, wherein the control program is created in such a way that it corresponds to a multiply modified block diagram in which, after a first modification of the block diagram, one or more further identifications of a block pair that is designed according to i) and/or ii) and corresponding modification of the block diagram take place.

5. The method according to claim 1, wherein when a block pair that is designed according to i) and/or ii) is identified during creation of the control program, a warning is generated.

6. The method according to claim 1, wherein the second block of the block pair is designed as a selector block or as an assignment block.

7. The method according to claim 1, wherein the first and second blocks of the block pair carry out inverse operations and/or opposite operations.

8. The method according to claim 1, wherein the first and second blocks of the block pair are designed in such a way that they carry out:
additive inverse operations,
logical inverse operations,
bitwise inverse operations,
inverse mathematical functions,
multiplicative inverse operations,
opposite data type conversions, and/or
linkages thereof; and/or
wherein the first and second blocks of the block pair are designed in such a way that they carry out linkages of operations which as a whole are inverse to one another.

9. The method according to claim 1, wherein creating the control program for the target platform from the graphical control model (12) of the development platform comprises the steps:
generating an intermediate representation from the graphical control model;
optimizing the generated intermediate representation; and
creating the control program for the target platform by translating the optimized intermediate representation, and
wherein, at least one of the steps and/or the step of generating the intermediate representation includes identifying block pairs that are designed according to i) and/or ii).

10. The method according to claim 9, wherein when a block pair that is designed according to i) is identified, the intermediate representation is created in such a way that it corresponds to a modified block diagram in which a branch prior to the first block, via the input signal of the first block, drives a successor block of the second block while bypassing the first and second blocks.

11. The method according to claim 9, wherein when a block pair that is designed according to ii) is identified, the intermediate representation is created in such a way that it corresponds to a modified block diagram in which a branch prior to the first block, via the input signal of the first block, drives the second reparameterized block while bypassing the first block, and for the reparameterized block the input signal of the operation that uses the intermediate result (Aux₄) is replaced by the input signal of the first block.

12. The method according to claim 10, wherein the optimizing of the generated intermediate representation includes renewed identification of block pairs that are designed according to i) and/or ii) in the modified block diagram corresponding to the intermediate representation, and/or includes generation of an optimized intermediate representation that corresponds to a multiply modified block diagram in which after a first modification of the block diagram, one or more further identifications of a block pair that is designed according to i) and/or ii) and corresponding modification of the block diagram take place.

13. A method for configuring a target platform designed as a control unit, the target platform comprising at least one processing unit and at least one sensor and/or actuator for detecting data of a physical process and/or acting on a physical process, the method comprising:
reading in a graphical control model of a development platform;
creating a control program for the target platform from the read-in graphical control model using the method according to claim 1;
generating an executable code for the processing unit of the target platform by compiling the created control program;
transferring the generated executable code to the target platform and/or storing the generated executable code on a nonvolatile memory of the target platform and/or executing the generated executable code by the processing unit of the target platform.

14. A device for data processing, comprising a processor to carry out the method according to claim 1.

15. A computer program product that includes commands which, when the program is executed by a computer, prompt the computer to carry out the method according to claim 1.
